(19) United States
(12) Patent Application Publication
(10) Pub. No.: US 2012/0076558 A1
(43) Pub. Date: Mar. 29, 2012

(54) METHOD AND DEVICE FOR GENERATING A PRESPECIFIED GLOSS PATTERN ON A TONER IMAGE

(76) Inventor: Detlef Schulze-Hagenest, Molfsee (DE)

(21) Appl. No.: 13/133,462

(22) PCT Filed: Nov. 30, 2009
(86) PCT No.: PCT/EP09/66075

§ 371 Date: Dec. 16, 2011

(30) Foreign Application Priority Data
Dec. 30, 2008 (DE) 10 2008 063 320.8

(51) Int. Cl. G03G 15/20; B29C 35/08; B26F 1/24; G03G 13/20; B23P 17/00

(52) U.S. Cl. 399/341; 29/592; 83/866; 264/400

(57) ABSTRACT

The invention describes a method and a device for generating a prespecified gloss pattern on a toner image in order to develop a detection property of said toner image. In the method, toner that is first heated to above its glass transition temperature is brought into contact with a glosser belt, said glosser belt having—corresponding to the gloss pattern to be generated—at least one first area displaying a first surface roughness and at least a second area displaying a second surface roughness and/or displaying a different elevation whereas a plurality of second areas is provided within the first area displaying a specific pattern, which repetition on other glosser belts is not allowed so that an identification of specific glosser belts and thus an identification of a glosser device is easier. Subsequently, while the toner is in contact with the glosser belt, said toner is cooled to below its glass transition temperature. The device comprises at least one first glosser belt, said glosser belt having—corresponding to the gloss pattern to be generated—at least one first area displaying a first surface roughness and at least a second area displaying a second surface roughness and/or displaying a different elevation, and comprising at least one heat source for heating the toner to above its glass transition temperature.

### TECHNICAL FIELD OF THE INVENTION

The present invention relates to a method and a device for generating a prespecified gloss pattern on a toner image.

### BACKGROUND OF THE INVENTION

It is known in printing technology to adjust the gloss of a toner image by means of a so-called glosser belt. In conjunction with this, a glosser belt is a belt displaying minimal surface roughness. The glosser belt is brought into contact with the toner while said toner has been or is being heated to a temperature above said toner's glass transition temperature. As a result of this, the surface structure of the glosser belt is impressed into the surface of the toner image. Depending on the surface roughness of the glosser belt, a prespecified gloss is attained.

Usually, it is desirable that the glosser belt exhibit a surface roughness that remains uniform in order to produce a uniform gloss on the toner image.

Furthermore, it is known in printing technology to influence certain properties of a print in order to identify original prints. For example, it has been suggested by Canon at the International Security Printing Conference in Prague, May 12 to 14, 1994, to provide a coded pattern of yellow dots within a print, said dots being arranged in such a manner that they are invisible to the human eye and do not impair the image quality. An appropriate identification unit, however, is able to detect the pattern of yellow dots. Inasmuch as the pattern can be specifically coded for each copier, it is possible to detect the printer on which specific copies were made. The pattern of yellow dots is controlled by software, so that an interference with the software could eliminate the advantage of any tracking. WO 2005/091084 shows a device and a method to create a predetermined gloss pattern on a toner image. The method uses a glosser belt, showing a surface roughness corresponding to the gloss pattern to be achieved, which is contacted with the toner, that is heated above its glass transition temperature. The surface of the glosser belt may show a textured structure.

DE 600 28 257 T2 equivalent with EP 1 273 459 B1 describes a device and a method for production of pictures of high gloss, whereby the substrate, covered with a toner image, passes a nip between a first and a second roller. This may result in plasticization of the toner image. One roller can be realized as embossing roller to emboss a holographic pattern into the toner image.

Additionally a marking system is known from EP 1 739 504 A, that is able to deposit a radiation sensitive toner on a substrate and radiate the toner selectively to modify its gloss characteristic. By means of this it is possible to generate different areas with different gloss characteristics.

### SUMMARY OF THE INVENTION

The object of the present invention is to allow an alternative form of identification of specific printers.

In accordance with the invention, this object is achieved by a method in accordance with Claim 1 and by a device in accordance with Claim 11. This object is achieved by a method to modify a glosser belt comprising areas with different surface characteristics according claim 32. Additional embodiments of the invention result from the subclaims.

In particular, a method for generating a prespecified gloss pattern on a toner image is provided, wherein a toner is heated to above its glass transition temperature, brought into contact with a glosser belt, said glosser belt having—corresponding to the gloss pattern to be generated—at least one first area displaying a first surface roughness and at least one second area displaying a second surface roughness and/or displaying a different elevation, and the toner is cooled to below its glass transition temperature while said toner is in contact with the glosser belt. The above-described method allows the provision of an identification mark on a toner image via a prespecified gloss pattern by means of hardware. This makes it possible to mark, for example, original prints so as to be able to distinguish them from other prints or copies; and, furthermore, makes it possible to identify the print of specific printing machines that use a specific glosser belt. If this method is used, the toner may already come into contact with the glosser belt, while said toner is still at a temperature below its glass transition temperature, and only be heated to above its glass transition temperature while said toner is in contact with the glosser belt. Alternatively, the toner that has already been heated to above its glass transition temperature can subsequently be brought into contact with the glosser belt.

Preferably, the at least one second area produces a gloss difference relative to the environment on the toner surface, said gloss difference not being detectable without technical aids in order to prevent impairment of the image. To accomplish this, the second area preferably has dimensions of the size of one millimeter or smaller and, in particular, on the order of one tenth of a millimeter or smaller.

In accordance with a particularly preferred embodiment of the invention, a plurality of second areas is provided within the first area displaying a prespecified pattern in order to provide a greater independence of potential individual scratches on the image that could locally impair the gloss. The pattern is preferably specific of the glosser belt that is used in order to be able to provide a distinction between different glosser belts and thus different printing machines and glosser units. In order to make the toner surface or the entire toner less sensitive to environmental influences, the polymer chains of the toner are preferably cross-linked while said toner is being heated to a temperature above the glass transition temperature. To accomplish this, the toner is maintained, for example, for a period of at least one second, at a temperature above the glass transition temperature of the toner, which leads to a cross-linking reaction specifically in the case of thermally cross-linking toners. For this process, the toner is preferably maintained at a temperature above the glass transition temperature of the toner for a period of 1 to 10 seconds. Alternatively or also additionally, UV radiation may be applied to the toner while it has a temperature above the glass transition temperature of the toner in order to achieve cross-linking in a UV-cross-linking toner.

In the case of duplex-printed printing substrate, said printing substrate is preferably received sandwich-like between two glosser belts, each having one first area displaying a first surface roughness and at least one second area displaying a second surface roughness and/or displaying a different elevation in order to be able to simultaneously adjust the gloss on both sides of the printing substrate.

The object of the invention is also achieved with a device for generating a prespecified gloss pattern on a toner image, said device comprising at least one first glosser belt, said glosser belt having—corresponding to the gloss pattern to be generated—at least one first area displaying a first surface roughness and at least one second area displaying a second surface roughness and/or displaying a different elevation, and said device further comprising at least one heat source for heating the toner to above its glass transition temperature. Such a device allows the aforementioned advantages.

Preferably, at least one cooling device is provided, said device being arranged so as to cool the toner in the region of the glosser belt. The cooling device allows a more compact glosser belt because an active cooling of the toner to below its glass transition temperature is made possible.

In order not to impair the image the second area preferably has dimensions in the order of one millimeter or smaller and, in particular, in the order of one tenth of a millimeter or smaller.

In a particularly preferred embodiment of the invention, a plurality of second areas is provided within the first area with a prespecified pattern, as a result of which, on the one hand, good detectability of the specific pattern and, on the other hand, independence of individual local scratches are achieved. In order to allow an identification in view of the origin of the toner image, the pattern is preferably specific of the glosser belt that is being used.

In one embodiment of the invention, at least one UV radiation source is provided, said UV radiation source being arranged in such a manner that it applies UV radiation through the glosser belt. Thus, UV cross-linking of the toner is made possible. Furthermore, a second heat source may be provided, said second heat source being arranged—viewed in the direction of movement of the glosser belt—downstream of the first heat source and being suitable for maintaining the toner at a temperature above its glass transition temperature. By holding the temperature of the toner above its glass transition temperature, a thermal cross-linking of said toner is achieved on the one hand and when a UV radiation is applied to the toner, a UV cross-linking is at the same time achieved on the other hand.

In one embodiment of the invention, at least one heat source is provided that is suitable for heating the toner in a non-contact manner in order to impair the toner image as little as possible. At least one heat source may comprise a microwave applicator, an IR radiation source or a radiation source with an IR and a UV component, the IR and UV components, each, amounting to at least 20%.

In one embodiment, the first heat source comprises two rollers that are biased relative to each other, at least one of which rollers can be heated via an appropriate heating device, the glosser belt being passed through a nip between the rollers.

In order to allow a simultaneous gloss adjustment of a duplex-printed printing substrate, preferably, a second glosser belt is provided, said second glosser belt contacting the first glosser belt in a work area and having—corresponding to the gloss pattern to be generated—at least one first area displaying a first surface roughness and at least one second area displaying a second surface roughness and/or displaying a different elevation.

Preferably, at least one glosser belt consists of an anti-adhesive material or is coated with such a material in order to allow an easy detachment of the toner image. For this, for example, at least one glosser belt consists of a polyimide material or is coated with such a material. Preferably, at least one glosser belt consists of a seamless belt material, thus preventing that a seam of the glosser belt will disadvantageously affect the gloss. Alternatively, it is also possible for a glosser belt to have an essentially flat exterior surface in order not to have the gloss affected despite a seam. At least one glosser belt consists of a transparent material in order to allow an IR and/or UV irradiation of the toner.

A method to form a glosser belt is provided as well characterized by treating a glosser belt with one first area displaying a first surface roughness to form a plurality of second areas displaying a second surface roughness and/or displaying a different elevation within the first area, whereas the second pattern is specific for the glosser belt and repetition upon other glosser belts is not allowed. Images produced with such a method allow to check authenticity of the glosser belt and the glosser device used.

The second areas can be easily formed by perforation of the glosser belt. A needle or a multitude of needles or at least one laser, that impacts the glosser belt can be used as well.

### BRIEF DESCRIPTION OF THE DRAWINGS

Hereinafter, the invention will additionally be explained in greater detail with reference to the drawings.

FIG. 1 is a schematic side view of an exemplary glosser device;

FIG. 2 is a side view of an alternative glosser device;

FIG. 3 is a plan view of a glosser belt in accordance with the invention; and

FIG. 4 is a temperature/time diagram of a method for generating a typical gloss pattern on a toner image in accordance with one exemplary embodiment.

### DETAILED DESCRIPTION OF THE INVENTION

The relative concepts such as, e.g., left, right above and under, used in the description hereinafter relate to the drawings and are not intended to restrict the application in any manner.

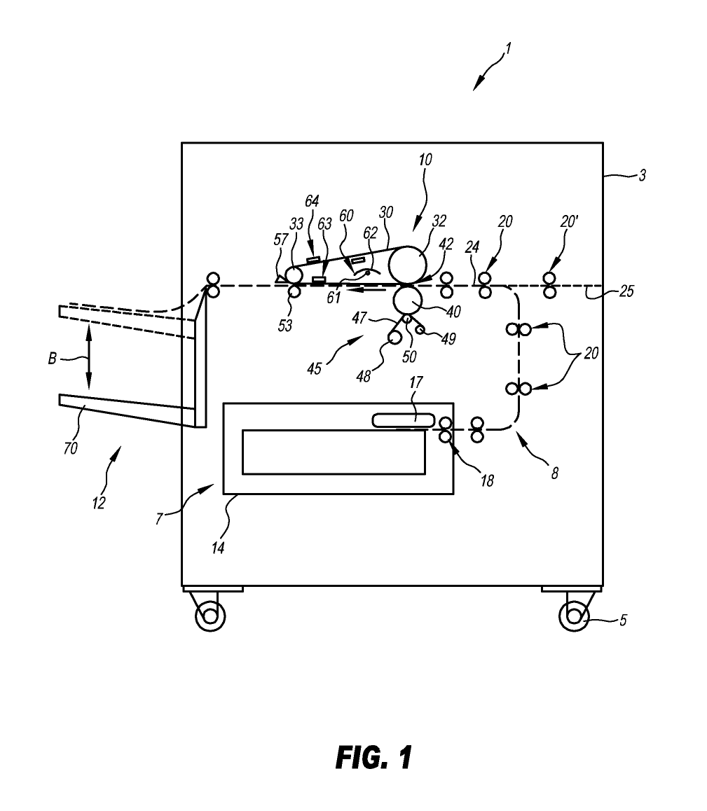

FIG. 1 shows a schematic side view of a glosser device 1 that is depicted as a free-standing unit. However, it may, for example, also be integrated in the paper moving path of a printing machine and, at the same time, serve as a fusing unit in addition to performing its glosser function. As shown, the glosser device 1 comprises a housing 3 that is supported by a plurality of wheels 5 (two of which are shown). The wheels 5 allow a flexible placement of the glosser device 1. Although the housing 3 is shown being supported by wheels 5, it should be noted that the glosser device may also be of the stationary type without wheels 5.

The housing 3 supports a sheet supply 7, a transport arrangement 8, a glosser arrangement 10 and a sheet tray 12. The sheet supply 7 may be any conventional sheet supply for supplying sheets to which toner has been applied. In particular, the sheet supply 7 comprises a housing 14, in which a cassette holds a stack of sheets. Inside the housing, a feeder mechanism is provided, said feeder mechanism consisting of a sheet pick-up device 17 and a pair of feeder rollers 18.

The transport arrangement 8 comprises a plurality of roller pairs 20 and guiding elements (not shown) to form a sheet transport path 24, as is indicated by a dashed line. The sheet transport path 24 extends from the sheet supply 7 to the glosser arrangement 10, through the glosser arrangement 10 and to the sheet tray 12. In addition, the transport arrangement may comprise a pair of feeder rollers 20′ that are arranged in such a manner that they feed sheets from an external source to the sheet transport path 24, as is indicated by the dotted line 25. Consequently, the transport arrangement 8 can supply sheets from the sheet supply 7 or from an external source to the glosser arrangement 10.

As previously mentioned, the glosser device may also be used in line with, e.g., a printer that would act as an external source of sheets. In such a case, the sheet supply 7 and part of the transport arrangement could be omitted, as is obvious to the person skilled in the art.

The glosser arrangement 10 is of the glosser belt type. The glosser arrangement 10 comprises a glosser belt 30 that is guided in a circulating manner around the guiding and/or transport rollers 32, 33. The roller 32 is arranged on an inlet side of the glosser arrangement 10, and the roller 33 is arranged on an outlet side of the glosser arrangement 10. The exterior surface of the glosser belt is extremely smooth, i.e., it displays minimal surface roughness because the roughness of the surface determines the gloss of the toner image, as will be described in greater detail hereinafter. The surface of the glosser belt is configured in such a manner that said glosser preferably imparts the toner with a gloss having a G20 gloss value approximately equal to or greater than 70.

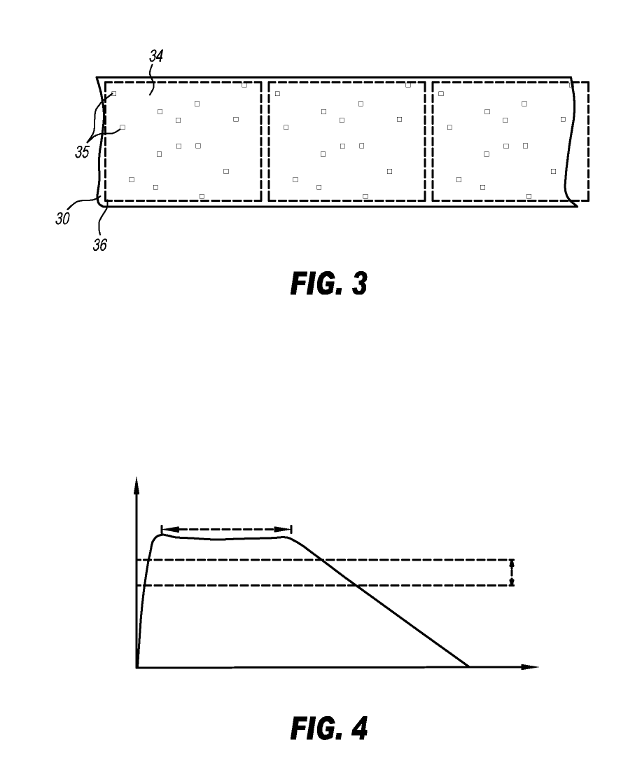

FIG. 3 shows a schematic plan view of a partial area of the glosser belt 30. In general, the glosser belt 30 has a first area 34 displaying a first surface roughness, as well as a plurality of second areas 35 displaying a different surface roughness. Alternatively, it is also possible that the areas 35 have the same surface roughness but a different elevation with respect to area 1, so that the first and second areas 34, 35 create different gloss characteristics of the toner. The second areas 35 are provided with a pattern that is specific to the glosser belt on the surface of the glosser belt 30. This pattern repeats periodically, as is indicated by the dotted areas 36. Although a periodic repetition of a basic pattern has been depicted, it should be noted that said repetition is not required and only a single, non-repeating, pattern of areas 34, 35 may be provided.

Each of the second areas 35 has dimensions that generate gloss differences in a toner image, said gloss differences not being detectable without technical aids. To accomplish this, the second areas preferably have dimensions smaller than 1 mm and, in particular, smaller than one tenth of a millimeter. It is also possible for the gloss values produced by the two different areas 34, 35 to be relatively close next to each other so that they cannot be or can hardly be distinguished from each other without technical aids.

Although a plurality of second areas 35 is provided, a single second area 35 could be provided at a certain point of the glosser belt; however, a plurality of second areas 35 is preferred. These permit a certain independence with respect to, for example, individual scratches on a toner image, as will be explained in greater detail hereinafter.

In the embodiment shown by FIG. 1, the roller 32 is a heatable roller that comprises a hollow, cylindrical element of metal such as, for example, aluminum, and has a polished surface. The hollow interior of the cylindrical element contains a first, not illustrated, heating mechanism such as, for example, a heat lamp with variable thermal output. Alternatively, the roller 32 could also be heated by an external heating device, e.g., by contact with an externally arranged heating roller. It is also possible to arrange a resistance heating element inside the roller 32. During operation of the glosser arrangement 10, the roller 32 has typically been preheated to a temperature between 130° C. and 170° C.

A counter-pressure roller 40 is provided below the roller 32. The counter-pressure roller 40 can be rotated about an axis of rotation that is in horizontal alignment with the axis of rotation of the roller 32. The counter-pressure roller 40 is arranged in such a manner that it presses with a prespecified force against the roller 32 in order to form a nip 42 through which the glosser belt 30 and a printing substrate with toner applied may pass under pressure. The counter-pressure roller 40 comprises a cylindrical element, e.g., of aluminum. An elastic layer, e.g., of an RTV thermoplastic material, having a thickness of approximately 3-5 mm is provided around the cylindrical element. The counter-pressure roller 40 may also be provided with a separate heating mechanism.

As previously mentioned, the counter-pressure roller 40 is pressed with a prespecified force against the roller 32. This prespecified force deforms the elastic surface in the nip 42, thus defining the pressure in the nip and the nip width. An adjustment mechanism may be provided in order to optimize the pressure and the nip width for different printing substrates, in particular for printing substrates having different thicknesses.

As is shown by FIG. 1, a cleaning mechanism 45 for the counter-pressure roller 40 is provided. The cleaning mechanism comprises a cleaning belt 47 that extends from a supply spool 48 to a take-up spool 49 via a contact roller 50. The contract roller 50 presses the cleaning belt 47 against the counter-pressure roller 40 in order to clean the latter. However, it is possible to use any cleaning mechanism instead of the specifically shown cleaning mechanism 45 in order to provide proper cleaning of the counter-pressure roller 40.

For forming a transport nip 55, a roller 53 is provided below the roller 33. The diameter of the roller 33 is substantially smaller than the diameter of the roller 32. The roller 33 has only the function of a guide for the glosser belt. For this purpose, the roller 33 may be ball-shaped in order to provide proper tracking of the glosser belt 30 on said glosser belt's circulating path.

A stripper 57 is provided on the outlet end of the transport nip 55 in order to provide a good separation of the toner-carrying printing substrate from the glosser belt 30.

Furthermore, the glosser arrangement 10 comprises a second heating mechanism 60 such as, for example, a lamp with variable power output, said lamp being provided in the space between the rollers 32 and 33 and being circumscribed by the glosser belt 30. The second heating mechanism 60 is arranged in such a manner that it heats a portion of the glosser belt, said portion extending along the sheet transport path 24. Alternatively, it is also possible, when the glosser belt 30 is transparent, for a printing substrate with the toner applied and directly located under said glosser belt to be heated with infrared radiation, for example. In the illustrated embodiment in accordance with FIG. 1, the heating mechanism 60 specifically comprises an IR lamp 61 and a reflector 62, said reflector reflecting the IR radiation to the glosser belt 30. The IR lamp 61 may also comprise a UV component, provided a UV-cross-linking toner is being used on the printing substrate. In this instance, the UV radiation would provide a UV cross-linking of the toner during a gloss adjustment, thus imparting the resultant toner image with better stability, in particular also with a higher glass point. Alternatively, the second heating mechanism 60 could also be arranged in the vicinity of the glosser belt 30 or even be integrated in said glosser belt. Other types of heating arrangements such as, for example, resistance heating elements, microwave applicators, hot air sources, etc., could also be provided.

The glosser arrangement 10 also comprises a cooling arrangement 63 such as, for example, a cool air blower that is arranged in the space between the rollers 32 and 33 and is circumscribed by the glosser belt 30. The cooling arrangement 63 is arranged along the sheet transport path 24, downstream of the second heating mechanism 60, and may blow, e.g., air at the glosser belt 30 in order to cool said glosser belt. The air may be, e.g., non-cooled air from the cooling arrangement's environment, but the air may also be especially cooled air and/or otherwise conditioned air displaying a suitable flow rate.

A cleaning station 64 is provided for cleaning an exterior surface of the glosser belt 30 while the glosser arrangement 10 is being operated. The cleaning station 64 is arranged above the glosser belt 30 in order to avoid any interference with a printing substrate and toner while the gloss is being adjusted. Any suitable cleaning mechanism may be used in the cleaning station 64. The cleaning mechanism should ensure that the surface characteristics of the exterior side of the glosser belt 30 will not or not substantially change over time. To accomplish this, the cleaning mechanism should be able to remove from the exterior side of the glosser belt any substances that would impair the surface characteristics, in particular any particulate contaminants, including toner particles, dust and fibers. In some cases, the cleaning station 64 may be omitted, i.e., if it can be ensured that the contaminants on the exterior surface of a glosser belt are reliably transferred to the surface of the counter-pressure roller 40 and then removed therefrom by the cleaning mechanism 45. Preferably, the glosser belt is of a type that does not need any aids such as, for example, oil or another means aiding the removal of the toner image. If such aids need to be used, an appropriate station for the application of such aids must be provided, e.g., a station for “oiling” an exterior surface of the glosser belt.

The sheet tray 12 comprises a height-adjustable support 70 as indicated by the double-headed arrow B. The dashed line shows the sheet support 70 in a raised position for receiving printing substrates at the end of the sheet transport path 24. The solid line shows the sheet support 70 in a lowered position.

The device comprises a suitable, not illustrated, control for controlling the operation of the individual elements such as, for example, the transport mechanism, the drive for the glosser belt, the heating mechanism, etc. Of course, it is also possible to provide several controls.

Hereinafter, the operation of the glosser device 1 in accordance with FIG. 1 will be explained in greater detail with reference to FIG. 4.

First, it is assumed that the sheet supply 17 is loaded with printing substrate with toner applied to one side. The toner is sufficiently fused to the printing substrate so that it is not impaired by the transport mechanism 8. The toner, for example, is a thermally cross-linking toner that has a first glass transition temperature TG1, for example, in a range of from 45° C. to 75° C., prior to the hereinafter described gloss adjustment operation. For example, the toner may be a dry toner having polymer chains that form the cross-links when they are heated above the glass transition temperature of the toner. Here, the glass transition is understood to be the mid-point of the temperature during the glass transition phase.

One of the printing substrates is taken up by the sheet supply 7 and transported along the sheet transport path 24 to the glosser arrangement 10. The printing substrate is transported in such a manner that the toner points to the roller 32 and to the glosser belt 30 when said printing substrate enters into the nip 42. The glosser belt 30 is circulated around the rollers 32 and 33 at a speed of approximately 15 cm per second or faster. Alternatively, the printing substrate may also be fed—via the transport rollers 20′—through an external source such as, for example, an electrophotographic printing machine.

The roller 32 is heated to a temperature between 130° C. and 170° C. As a result of the fact that the roller is heated to a temperature substantially above the glass transition temperature TG1 of the toner, the temperature of the toner is also rapidly raised to above the glass transition temperature of said toner due to the pressure in the nip 42.

This is illustrated, e.g., by the temperature/time diagram in accordance with FIG. 4, which shows the temperature of the toner along a straight line perpendicular to the transport direction while the printing substrate is being moved through the glosser arrangement 10.

As is shown by FIG. 4, the temperature of the toner is rapidly elevated to above the first glass transition temperature TG1 of the toner so that said toner will melt.

The second heating mechanism 60 maintains the toner above said toner's glass transition temperature, thus allowing thermal cross-linking of said toner, which, in turn, brings about a simultaneous elevation of the glass transition temperature to a value TG2. In FIG. 4, t1 represents the time interval during which the heating mechanism 60 maintains the toner at a temperature above the glass transition temperature of the toner. The time t1 is preferably in the range of from 1 to approximately 10 seconds. This time interval allows a substantial cross-linking, if a thermally cross-linking toner is provided, thus rendering the resultant toner layer substantially more stable. As mentioned above, a UV radiation source may be additionally provided or also integrated in the second heating mechanism 60, so that, in addition to thermal cross-linking, UV cross-linking may also take place.

As the printing substrate is being moved on, it exits from the region of the second heating mechanism 60 and thus arrives in the region of the cooling arrangement 63 in which said printing substrate is cooled to below the new glass transition temperature TG2 of the toner, as is shown in FIG. 4. Subsequently, the printing substrate with the applied toner image is moved out of the glosser arrangement 10 and on to the tray 12.

While the toner is heated to above its glass transition temperature TG2 and up to its being cooled to below its glass temperature TG2, said toner is in contact with the surface of the glosser belt 30, said glosser belt having the pattern of the first and second areas 34, 35 shown in FIG. 3, for example. This means that different gloss characteristics in different surface areas of the toner image are generated on the surface of the toner image. Without technical aids, these gloss differences cannot be detected or they can be detected only with difficulty, because the generated gloss differences have dimensions smaller than 1 mm, preferably smaller than one tenth of a millimeter. Alternatively, it is, of course, also possible to provide large-area gloss differences that can be detected with the naked eye. Such detectable gloss differences may also be provided in addition to gloss differences that cannot be detected without aids.

A prespecified pattern of the glosser belt, that is unique for the glosser belt used may allow an identification of the glosser device 1 or of a printing machine on which the glosser device 1 is provided.

Although, in the above device, the cooling mechanism 63 has cooled the toner to below its glass transition temperature before the printing substrate and the toner are separated from the glosser belt, this is not always necessary. Depending on the state of cross-linking, a separation from the glosser belt could also be possible above the glass transition temperature, without generating artifacts at the time of separation.

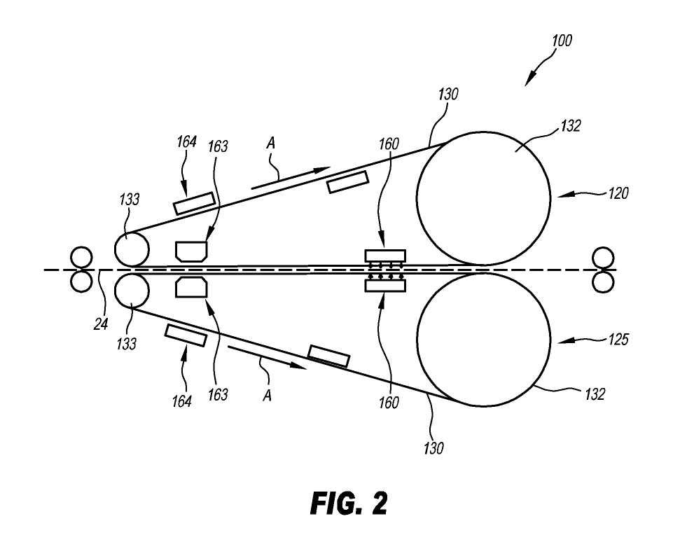

FIG. 2 shows an alternative glosser arrangement 100 that can be used, for example, in the glosser device 1 instead of in the glosser arrangement 10. The glosser arrangement 100, again, is of the glosser belt type. The glosser arrangement 100 possesses a first glosser belt arrangement 120 comprising a circulating glosser belt 130 that may be of the same type as the above-described glosser belt 30. The glosser belt 130 is guided in a biased manner around a roller 132 and a roller 133. The roller 132 is provided on the inlet end of the glosser arrangement 100, and the roller 133 is provided on the outlet end of said glosser arrangement. Each of the two rollers 132 and 133 can be rotated about a respective axis of rotation, and one of the rollers 132, 133, preferably roller 132, is coupled with a driving mechanism for rotating the respective roller in order to thus move the glosser belt 130 in the direction of the arrow A around the rollers 132, 133. The roller 132 may be of the same type as the above-described roller 32. Said roller may also comprise a first heating mechanism (not illustrated) such as, for example, a lamp with variable output. Again, the roller 133 is of the same type as the above-described roller 33.

The first glosser belt arrangement 120 also comprises a second heating mechanism 160 such as, for example, a lamp with variable output. The second heating mechanism, again, is arranged in the space between the rollers 132 and 133 and circumscribed by the glosser belt 130. The second heating mechanism 160 is again arranged so as to heat a portion of the glosser belt 130 along the sheet transport path 24. The first glosser belt arrangement 120 also comprises a cooling arrangement 163 such as, for example, an air blower that is arranged in the space between the rollers 132 and 133 and is circumscribed by the glosser belt 130. The cooling arrangement 163 is arranged along the sheet transport path 24, downstream of the heating mechanism 160. The heating and cooling mechanisms 160 and 163 may be of the same type as described above with reference to FIG. 1.

The first glosser belt arrangement 120 also comprises a cleaning station 164 for cleaning an exterior surface of the glosser belt 130 while said glosser belt is being operated. Said cleaning station is arranged in the same manner as the cleaning station 64 in the glosser arrangement 10 in accordance with FIG. 1 and may be of the same type.

The glosser belt arrangement 100 also comprises a second glosser belt arrangement 125 that essentially has the same design as the first glosser belt arrangement 120. The second glosser belt arrangement 125, however, is arranged in reverse order below the first glosser belt arrangement 120 so that the sheet transport path 24 may extend in between. For the second glosser belt arrangement 125, the same reference symbols are used as for the first glosser belt arrangement 120.

The respective rollers 132 on the input end of the glosser arrangement 100 are biased relative to each other in order to form a nip in between. One or both of the rollers 132 may have, on the exterior circumference, an elastic layer, e.g., of an RTV thermoplastic material, similar to the counter-pressure roller 40 in accordance with FIG. 1. In the glosser arrangement 100, preferably both rollers 132 can be heated via an appropriate heating mechanism, although it is also possible that only one of said two rollers is heatable. Both rollers 132 are coupled with a drive, i.e., preferably with a common drive for a synchronous rotation of said rollers. Alternatively, it would also be possible to couple only one of the rollers 132 with a drive.

The rollers 133 on the outlet end of the glosser device 100 are arranged so as to create a transport nip between them. Although not illustrated, respective strippers may be provided adjacent to the rollers 133.

Again, each of the respective glosser belts 130 comprises first areas having a first surface roughness as well as second areas having a second surface roughness, as illustrated in FIG. 3. The glosser belts 130 each comprise predetermined and unique patterns of first and second areas, and it is possible to provide patterns with different unique surface roughnesses on different glosser belts. If no repetition of patterns on glosser belts is allowed, an identification of specific glosser belts and thus an identification of a glosser device is easier. Preferably, the glosser belts 130 should be of the seamless type and optionally be transparent to UV radiation in order to allow a UV irradiation of a toner image located below said glosser belts. Preferably, the glosser belts 130 should consist of an anti-adhesive material or be coated with such a material. A polyimide material would be obvious as the material for the glosser belt 130. Of course, this also applies analogously to the glosser belt 30 described in FIG. 1. Such a pattern that is predetermined and unique for each glosser belt, can be achieved by a corresponding perforation of the glosser belt. It can be achieved e.g. by a needle or a multitude of needles that are addressed in a specific way like in a needle printer to create a pattern on a glosser belt. Particularly it is possible as well to provide the predetermined unique pattern of the glosser belt by a laser, which either modifies the surface structure of the glosser belt or perforates it. Specifically patterns can be provided in a first homogeneous area of the glosser belt as well as in different area of the glosser belt.

The operation of the glosser arrangement 100 is essentially the same as the operation of the glosser arrangement 10 described above with reference to FIG. 1. As a result of the two glosser belt arrangements 120, 125 it is possible however, in the case of printing substrates carrying toner images on both sides, that the gloss can be adjusted on both sides at the same time. In so doing, again, specific gloss patterns may be adjusted on the respective toner images, which gloss patterns may be the same or also different on the two sides.

The present invention was described with reference to preferred embodiments without, however, being restricted to the specifically illustrated embodiments.

In particular, as already mentioned, the glosser device may also be integrated in an electrophotographic printing machine and perform a fusing function in addition to a glosser function.

1. Method for generating a prespecified gloss pattern on a toner image, said method comprising the following steps:
bringing a toner that has been heated to above its glass transition temperature into contact with a glosser belt, said glosser belt having—corresponding to the gloss pattern to be generated—at least one first area displaying a first surface roughness and at least one second area displaying a second surface roughness and/or displaying a different elevation, cooling of the toner to below its glass transition temperature while said toner is in contact with the glosser belt and whereas a plurality of second areas is provided within the first area displaying a specific pattern, which repetition on other glosser belts is not allowed so that an identification of specific glosser belts and thus an identification of a glosser device is easier.

2. Method as in claim 1, wherein at least one second area produces a gloss difference relative to the environment on the toner surface, with said gloss difference not being detectable without technical aids.

3. Method as in claim 1, wherein the second area has dimensions in the order of one millimeter or smaller.

4. Method as in claim 3, the second area has dimensions in the order of 1/10 millimeter or smaller.

5. Method as in claim 1, wherein the toner is heated to above its glass transition temperature while said toner is in contact with the glosser belt.

6. Method as in claim 1, whereby effecting a cross-linking reaction of polymer chains of the toner while said toner is being heated to a temperature above the glass transition temperature.

7. Method as in claim 1 wherein the toner is maintained at a temperature above the glass transition temperature of the toner for a period of at least 1 second.

8. Method as in claim 7, wherein the toner is maintained at a temperature above the glass transition temperature of the toner for a period of 1 to 10 seconds.

9. Method as in claim 1, wherein UV radiation is applied to the toner while it has a temperature above the glass transition temperature of the toner.

10. Method as in wherein toner is applied to opposite sides of a printing substrate and that, in the course of the method, the printing substrate is received sandwich-like between two glosser belts, each comprising one first area displaying a first surface roughness and at least one second area displaying a second surface roughness and/or displaying a different elevation.

11. Device for generating a prespecified gloss pattern on a toner image, said device comprising:
at least one first glosser belt, said glosser belt having—corresponding to the gloss pattern to be generated—at least one first area displaying a first surface roughness and at least one second area displaying a second surface roughness and/or displaying a different elevation; and comprising at least a first heat source for heating the toner to above its glass transition temperature whereas on the glosser belt a plurality of second areas is provided within the first area displaying a specific pattern, which repetition on other glosser belts is not allowed so that an identification of specific glosser belts and thus an identification of a glosser device is easier.

12. Device as in claim 11, whereby one cooling device that is arranged so as to cool toner in the region of the glosser belt.

13. Device as in claim 11 wherein the second area has dimensions in the order of one millimeter or smaller.

14. Device as in claim 13, wherein the second area has dimensions in the order of 1/10 millimeter or smaller.

15. Device as in claim 11, whereby at least one UV radiation source that is arranged in such a manner that it applies UV radiation through the glosser belt.

16. Device as in claim 11, wherein at least a second heat source is provided, said second heat source being arranged—viewed in a direction of movement of the glosser belt—downstream of the at least one heat source and being suitable for maintaining the toner at a temperature above the glass transition temperature of the toner.

17. Device as in one of the claims 11 through 16, characterized in that at least one heat source is provided, said heat source being suitable for heating the toner in a non-contact manner.

18. Device as in claim 11, wherein at least one heat source comprises a microwave applicator.

19. Device as in claim 11, wherein at least one heat source comprises an IR radiation source.

20. Device as in claim 11, wherein at least one heat source comprises a radiation source with an IR and a UV component, the IR and UV components, each, amounting to at least 20%.

21. Device as in claim 11, wherein the first heat source comprises two rollers that are biased relative to each other, at least one of which rollers can be heated via an appropriate heating device, and the glosser belt being passed through a nip between the rollers.

22. Device as in one of the claim 11, whereby a second glosser belt, said second glosser belt contacting the first glosser belt in a work area and having—corresponding to the gloss pattern to be generated—at least one first area displaying a first surface roughness and at least one second area displaying a second surface roughness and/or displaying a different elevation.

23. Device as in claim 21, wherein at least one roller is a deflecting roller for a glosser belt.

24. Device as in claim 11, wherein at least one glosser belt consists of an anti-adhesive material or is coated with such a material

25. Device as in claim 11, wherein at least one glosser belt consists of a polyimide material or is coated with such a material.

26. Device as in claim 11, wherein at least one glosser belt consists of a seamless belt material.

27. Device as in claim 11, wherein at least one glosser belt has an essentially flat exterior surface.

28. Device as in claim 11, wherein at least one glosser belt consists of a transparent material.

29. Device as in claim 11, wherein the second areas are at least formed by means of mechanical impact to the glosser belt.

30. Device as in claim 11, wherein the second areas are at least formed by means of perforation of the glosser belt.

31. Device as in claim 11, wherein the second areas are at least formed by means of impact of a laser to the glosser belt.

32. Method to form a glosser belt comprising treating a glosser belt with one first area displaying a first surface roughness to form a plurality of second areas displaying a second surface roughness and/or displaying a different elevation within the first area, whereas the second pattern is specific for the glosser belt and repetition upon other glosser belts is not allowed.

33. Method as in claim 32, wherein the second areas are formed by mechanical impact to the glosser belt

34. Method as in claim 33, wherein the second areas are formed by perforation of the glosser belt.

35. Method as in claim 32, wherein the second areas are formed by a multitude of pinpricks, mechanically attached to the glosser belt.

36. Method as in claim 32, wherein the second areas are formed by a laser which acts upon the glosser belt.
